(19) United States
(12) Patent Application Publication
(10) Pub. No.: US 2017/0049148 A1
(43) Pub. Date: Feb. 23, 2017

(54) Pipe Snuffer with Removable Head

(71) Applicant: Donna Murphy, Dumfries, VA (US)

(72) Inventor: Donna Murphy, Dumfries, VA (US)

(21) Appl. No.: 15/243,427

(22) Filed: Aug. 22, 2016

Related U.S. Application Data
(60) Provisional application No. 62/207,955, filed on Aug. 21, 2015.

(51) Int. Cl. A24F 3/00; A24F 9/00

(52) U.S. Cl. CPC A24F 3/00; A24F 9/00; A62C 3/00

(57) ABSTRACT

A pipe snuffer with removable head. The pipe snuffer with removable head includes a base and a head, the base having a substantially cylindrical housing with a sidewall, a closed bottom, and an open upper end. The head is a substantially cylindrical element. A fastener is disposed on the base to removably secure it to the head. In one embodiment of the pipe snuffer removable head, the fastener is a female threading on the open upper end of the base and a male threading on the head. The base is made from fire resistant material and is configured to fit within the bowl of a pipe to a close tolerance. When the pipe snuffer with removable head is placed within a bowl of a lit pipe, the flame is extinguished, thus preserving the tobacco for future use.

### CROSS REFERENCE TO RELATED APPLICATIONS

This application claims the benefit of U.S. Provisional Application No. 62/207,955 filed on Aug. 21, 2015. The above identified patent application is herein incorporated by reference in its entirety to provide continuity of disclosure.

### BACKGROUND OF THE INVENTION

The present invention relates to pipe snuffers. More specifically, the present invention related to pipe snuffers with a removable handle.

Smoking pipes are devices used to burn and inhale the smoke of various substances, most commonly tobacco leaves. The tobacco is placed within a bowl of the pipe and ignited. When a user is finished using the pipe, the contents of the bowl must either be left to burn out or be actively extinguished. Often a user wishes to extinguish the tobacco to preserve the remaining leaves for future use. However, it can be difficult to efficiently extinguish the flame within a bowl. Accordingly, a device that is configured to be placed within a bowl, offering maximum coverage of the contents to prevent oxygen from feeding the flame and to efficiently extinguish the pipe is desired.

### SUMMARY OF THE INVENTION

In view of the foregoing disadvantages inherent in the known types of pipe snuffers now present in the prior art, the present invention provides a pipe snuffer wherein the same can be utilized for providing convenience for the user when wishing to extinguish the contents of a pipe bowl. The present system comprises a base and a head, the base having a substantially cylindrical housing with a sidewall, a closed bottom, and an open upper end. The head is a substantially cylindrical element. A fastener is disposed on the base to removably secure it to the head. In one embodiment of the pipe snuffer with removable head, the fastener is a female threading on the open upper end of the base and a male threading on the head. A user can easily remove and replace one head with an alternatively shaped head. The base is made from fire resistant material and is configured to fit within the bowl of a pipe to a close tolerance. When the pipe snuffer with removable head is placed within a bowl of a lit pipe, the flame is extinguished, thus preserving the tobacco for future use.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the base of the pipe snuffer with removable head.

FIG. 2 shows a perspective view of an embodiment of the base and the head of the pipe snuffer with removable head.

FIG. 3 shows a perspective view of an embodiment of the pipe snuffer with removable head placed within the bowl of a pipe.

FIG. 4 shows a perspective view of various embodiments of the pipe snuffer with removable head.

### DETAILED DESCRIPTION OF THE INVENTION

Reference is made herein to the attached drawings. Like reference numerals are used throughout the drawings to depict like or similar elements of the pipe snuffer. The figures are intended for representative purposes only and should not be considered to be limiting in any respect.

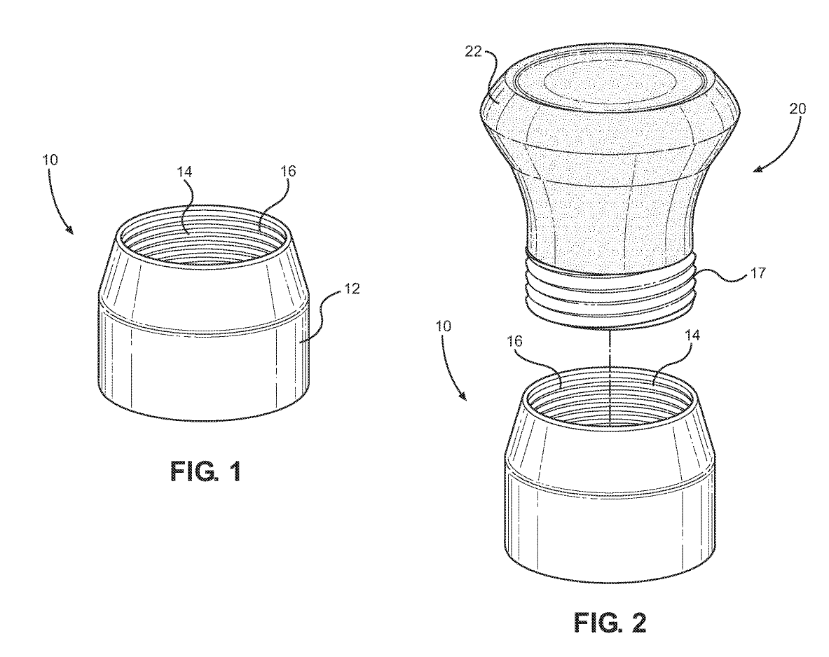

Referring now to FIGS. 1 and 2, there are shown perspective views of the head and base of the pipe snuffer with removable head. The pipe snuffer comprises a base 10 that is removably secured to a head 20. The base 10 comprises a substantially cylindrical housing 12 having a sidewall, a rounded closed bottom, and an open upper end 14. There is a lower fastener disposed on the open upper end 14 of the housing 12 of the base 10 that is configured to removably engage the head 20 of the pipe snuffer. In one embodiment of the base 10, the lower fastener is a female threading 16 disposed along an interior circumference of the open upper end 14. In one embodiment of the base 10, the cylindrical housing 12 tapers toward the open upper end 14. The bottom of the cylindrical housing 12 is a closed solid surface that is constructed from a fire-resistant material. For example, in one embodiment of the pipe snuffer, the base 10 is manufactured from a metallic material such as brass that having a melting temperature above 800 degrees Celsius.

The head 20 comprises a substantially cylindrical element having a first end and a second end. An upper fastener configured to engage the lower fastener of the base 10 is disposed on the second end of the head 20. In one embodiment of the head 20, the upper fastener comprises a collar with male threading 17 thereon. The male threading 17 is configured to be secured to the female threading 16 of the lower fastener of the base 10. In a further embodiment of the head 20, the first end flares outward, creating an ergonomically shaped top 22 for easier handling.

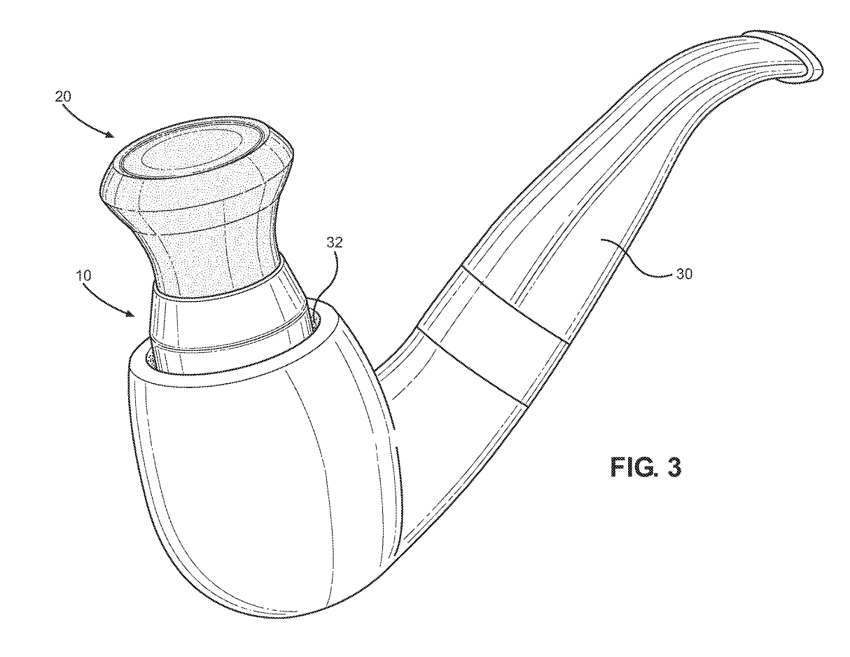

Referring now the FIG. 3, there is shown a perspective view of an embodiment of the pipe snuffer with removable head placed within the bowl of a pipe. A standard pipe 30 comprises a stem and a bowl 32. The bowl 32 is sized and shaped to hold tobacco leaves therein. In use, tobacco is placed within the bowl and ignited, wherein a user inhales smoke created from the burning tobacco through the stem. When a user has finished using the pipe 30, the lit tobacco can be left to burn out, or be actively extinguished. Extinguishing tobacco preserves the leaves for future use, reducing waste.

To extinguish the lit tobacco, the pipe snuffer is inserted into the cavity of the bowl 32. In one embodiment of the pipe snuffer, the base 10 of the present snuffer is configured to fit within the inner circumference of the bowl 32 of a pipe 30 within a close tolerance. The bottom of the base 10 is pressed against the tobacco, reducing oxygen and extinguishing the flame. The head 20 provides a convenient knob to handle the pipe snuffer easily. Additionally, further embodiments of the head 20 of the pipe snuffer comprise a material that has a low thermal conductivity, ensuring that the head 20 stays cool while a user is handling the pipe snuffer. For example, the material can have a thermal conductivity below 1 watt per meter kelvin. In one embodiment, the head 20 of the pipe snuffer can be constructed from wood.

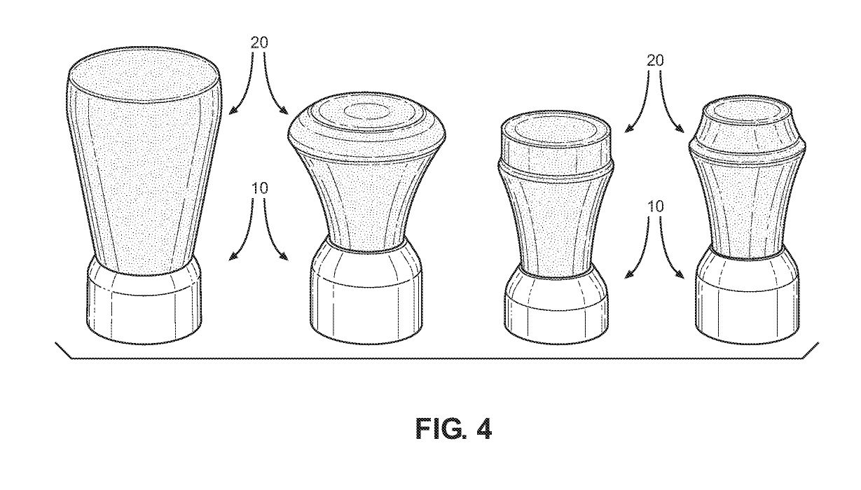

Referring to FIG. 4, there is shown a perspective view of various embodiments of the pipe snuffer with removable head. The base 10 of the pipe snuffer can come is a variety of shapes and sizes to accommodate pipe bowls of various diameters. The pipe snuffer is most effective when the diameter of the base 10 is in close tolerance of the interior diameter of the pipe bowl. Such a tight fit ensure maximum coverage of the tobacco and minimal allowance of oxygen, encouraging efficient extinguishing of the flame. The head 20 of the pipe snuffer varies in shape to allow for various designs. In one embodiment, the head 20 is frusto-conical in shape. Is another embodiment, the head 20 is wider at the first end with a ridge disposed along the circumference and tapers down to a narrower diameter at the second end. The various head shapes are designed to offer ergonomic handles for the pipe snuffer. Because the head 20 is removably attached to the base 10, a user can easily exchange one head 20 for another one depending on the intended usage. In some embodiments of the pipe snuffer with removable head, the head 20 comprises pressure treated hard wood with a decorative mark disposed thereon.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A pipe snuffer, comprising:
a base comprising a cylindrical housing having a sidewall, a rounded closed bottom, and an open upper end, wherein the base comprises a fire resistant material;
a head comprising a cylindrical element having thermal conductivity below 1 watt per meter kelvin;
a fastener configured to removably secure the base to the head.

2) The pipe snuffer with removable head of claim 1, wherein the head further comprises a first end and a second end, and wherein the fastener comprises a threading disposed along an interior circumference of the open upper end of the base and a corresponding threading disposed on the second end of the head.

3) The pipe snuffer with removable head of claim 1, wherein the fire resistant material has a melting point above 800 degrees Celsius.

4) An assembly of a pipe and a pipe snuffer, comprising:
the pipe snuffer comprising:
a base comprising a cylindrical housing having a sidewall, a rounded closed bottom, and an open upper end, wherein the base comprises a fire resistant material;
a head comprising a cylindrical element having thermal conductivity below 1 watt per meter kelvin;
a fastener configured to removably secure the base to the head;
the pipe comprising a bowl;
wherein a diameter of the base is equal to a close tolerance of a diameter of the bowl.

5) The pipe with a pipe snuffer with removable head configured to fit therein of claim 4, wherein the head further comprises a first end and a second end, and wherein the fastener comprises a threading disposed along an interior circumference of the open upper end of the base and a corresponding threading disposed on the second end of the head.

6) The pipe with a pipe snuffer with removable head configured to fit therein of claim 4, wherein the fire resistant material has a melting point above 800 degrees Celsius.
